(19) United States
(12) Patent Application Publication
(10) Pub. No.: US 2024/0012152 A1
(43) Pub. Date: Jan. 11, 2024

(54) METHOD FOR OPERATING A DETECTION DEVICE FOR DETERMINING TEMPERATURE-ADJUSTED DISTANCE VARIABLES, CORRESPONDING DETECTION DEVICE, AND VEHICLE HAVING AT LEAST ONE DETECTION DEVICE OF THIS KIND

(71) Applicant: Valeo Schalter und Sensoren GmbH, Bietigheim-Bissingen (DE)

(72) Inventors: Christoph Parl, Bietigheim-Bissingen (DE); Jonas Krause, Bietigheim-Bissingen (DE); Frank Selbmann, Bietigheim-Bissingen (DE)

(73) Assignee: Valeo Schalter und Sensoren GmbH, Bietigheim-Bissingen (DE)

(21) Appl. No.: 18/254,486

(22) PCT Filed: Nov. 23, 2021
(86) PCT No.: PCT/EP2021/082588

§ 371 Date: May 25, 2023

(30) Foreign Application Priority Data
Nov. 26, 2020 (DE) 10 2020 131 288.1

(51) Int. Cl. G01S 17/931; G01S 7/4915

(52) U.S. Cl. CPC G01S 17/931; G01S 7/4915

(57) ABSTRACT

A method for operating a detection device for determining distance variables in which distances characterise objects detected by the detection device is disclosed. From at least one amplitude-modulated electrical send signal at least one scanning signal is generated, which is sent into at least one monitoring region of the detection device. From at least one echo signal of at least one scanning signal reflected in the at least one monitoring region at least one amplitude-modulated electrical receive signal is determined. From at least one electrical send signal and at least one electrical receive signal at least one distance variable is determined. When determining the at least one distance variable at least one adjustment is carried out. A temperature adjustment is carried out in which at least one temperature adjustment variable is applied to at least one distance variable.

### TECHNICAL FIELD

The invention relates to a method for operating a detection apparatus for determining distance variables which characterize distances from objects detected by the detection apparatus, in which method
at least one scanning signal is generated from at least one amplitude-modulated electrical transmission signal and is transmitted into at least one monitoring region of the detection apparatus,
at least one amplitude-modulated electrical reception signal is ascertained from at least one echo signal of at least one scanning signal reflected in the at least one monitoring region,
at least one distance variable is ascertained from at least one electrical transmission signal and at least one electrical reception signal,
wherein, when ascertaining the at least one distance variable, at least one adjustment is carried out.

Furthermore, the invention relates to a detection apparatus for determining distance variables which characterize distances from objects detected by the detection apparatus, having at least one transmission device by means of which at least one scanning signal can be generated from at least one amplitude-modulated electrical transmission signal and transmitted into at least one monitoring region of the detection apparatus,
having at least one reception device by means of which at least one amplitude-modulated electrical reception signal can be ascertained from at least one echo signal of at least one scanning signal reflected in the at least one monitoring region,
having at least one distance ascertaining means for ascertaining at least one distance variable from at least one electrical transmission signal and at least one electrical reception signal
and having at least one adjustment means for carrying out at least one adjustment of the at least one distance variable.

Moreover, the invention relates to a vehicle having at least one detection apparatus for determining distance variables which characterize distances from objects detected by the detection apparatus relative to the vehicle,
having at least one transmission device by means of which at least one scanning signal can be generated from at least one amplitude-modulated electrical transmission signal and transmitted into at least one monitoring region of the detection apparatus,
having at least one reception device by means of which at least one electrical reception signal can be ascertained from at least one echo signal of at least one scanning signal reflected in the at least one monitoring region,
having at least one distance ascertaining means for ascertaining at least one distance variable from at least one electrical transmission signal and at least one electrical reception signal
and having at least one adjustment means for carrying out at least one adjustment of the at least one distance variable.

### PRIOR ART

US 2020/0018836 A1 discloses a distance measuring apparatus. The distance measuring apparatus is a TOF camera which measures the distance to an object e.g. by means of a phase difference method. The distance measuring apparatus comprises a light-emitting section, which emits reference light toward a target measurement space, a light-receiving section, which receives incident light from the target measurement space, and a distance image generating section, which generates a distance image to the object in the target measurement space. The distance measuring apparatus uses the distance to a reference object, which was calculated geometrically from the two-dimensional image, in order to calculate an adjustment amount for adjusting the distance image.

The invention is based on the object of designing a method, a detection apparatus and a vehicle of the type mentioned at the outset, in which distances from objects can be determined in an improved manner.

### DISCLOSURE OF THE INVENTION

The invention achieves this object for the method in that at least one temperature adjustment is carried out in which at least one temperature adjustment variable is applied to at least one distance variable, which temperature adjustment variable is specified individually for the at least one distance variable and a prevailing temperature.

According to the invention, a temperature adjustment is carried out by way of which the influence of the prevailing temperature on the determination of the distance variables is compensated for.

As is known, transmission and reception components within a detection apparatus may have temperature-dependent delays. The distance variables, which can be determined by the detection apparatus, may therefore also change with the system temperature. By way of the temperature adjustment according to the invention, the temperature influence is compensated for.

Advantageously, corresponding temperature adjustment variables can be specified for the entire temperature range to which the detection apparatus may be exposed. When using the detection apparatus in motor vehicles, influences by temperatures in the range for example between −40° C. and 85° C. can be compensated for using the specified dem Porto adjustment variable.

According to the invention, at least one individual temperature adjustment variable for a distance variable is applied to this at least one distance variable. In this way, a temperature influence can also be adjusted depending on the distance variable determined by the detection apparatus. Temperature influences at different distances, that is to say different distance variables, can thus be compensated for. Temperature influences which may vary over the measurable distances can thus also be compensated for.

Advantageously, the at least one detection apparatus can operate according to an indirect signal time-of-flight method. Optical detection apparatuses operating according to a signal time-of-flight method can be designed and referred to as time-of-flight (TOF) systems, light detection and ranging systems (LiDAR), laser detection and ranging systems (LaDAR), radar systems or the like. In an indirect signal time-of-flight method, it is possible to ascertain a phase shift of the reception signal with respect to the transmission signal, which phase shift is caused by the time-of-flight of the scanning signal to that of the corresponding echo signal. The distance of an object, at which the corresponding scanning signal is reflected, can be ascertained from the phase shift.

Advantageously, the detection apparatus can be configured as a laser-based distance measuring system. A laser-based distance measuring system can have, as the light source of a transmission device, at least one laser, in particular a diode laser. The at least one laser can be used to transmit in particular pulsed light scanning signals. The laser can be used to emit scanning signals in wavelength ranges that are visible or not visible to the human eye. Accordingly, at least one receiver can have a detector designed for the wavelength of the emitted light, in particular a point sensor, line sensor or area sensor, especially an (avalanche) photodiode, a photodiode linear array, a CCD sensor, an active pixel sensor, in particular a CMOS sensor, or the like. The laser-based distance measuring system can advantageously be a laser scanner. A laser scanner can be used to scan a monitoring region with an in particular pulsed scanning signal.

The invention can advantageously be used in vehicles, in particular motor vehicles. The invention can advantageously be used in land-based vehicles, in particular passenger vehicles, trucks, buses, motorcycles or the like, aircraft, in particular drones, and/or watercraft. The invention may also be used in vehicles that may be operated autonomously or at least semiautonomously. However, the invention is not restricted to vehicles. It can also be used in a stationary scenario, in robotics and/or in machines, in particular construction or transport machinery, such as cranes, excavators or the like.

The detection apparatus can advantageously be connected to at least one electronic control apparatus of a vehicle or of a machine, in particular a driver assistance system and/or a chassis control system and/or a driver information device and/or a parking assistance system and/or a gesture recognition system or the like, or can be part of such an apparatus, device or system. In this way, at least some of the functions of the vehicle or of the machine can be operated autonomously or semiautonomously.

The detection apparatus can be used to detect stationary or moving objects, in particular vehicles, persons, animals, plants, obstacles, roadway unevennesses, in particular potholes or rocks, roadway boundaries, traffic signs, free spaces, in particular parking spaces, precipitation or the like.

In one advantageous configuration of the method,
the at least one distance variable can be ascertained on the assumption that the at least one amplitude-modulated transmission signal and the at least one amplitude-modulated reception signal each have basic envelope curve shapes,
and at least one signal shape adjustment can be carried out in which deviations of real envelope curve shapes of the transmission signals and of the reception signals from the basic envelope curve shapes are adjusted.

Basic envelope curve shapes can advantageously be assumed to be envelope curve shapes which allow a simpler calculation than the real envelope curve shapes. For the actual measurement, use can be made of the real envelope curve shapes that are technically easier to realize. The signal shape adjustment can be used to match the at least one distance variable ascertained from the basic envelope curve shapes to the real envelope curve shapes. On the whole, the method for determining the distance variables can thus be realized more easily.

In a further advantageous embodiment, sinusoidal curve shapes can be used as basic envelope curve shapes for at least one transmission signal and at least one reception signal and/or triangular curve shapes, sawtooth curve shapes or the like can be used as real envelope curve shapes.

The at least one reception signal can be easily calculated using trigonometry based on sinusoidal curves. Amplitude-modulated transmission signals, scanning signals, echo signals and reception signals based on triangular curves, sawtooth curves or the like can be implemented in a technically simpler manner and are less susceptible to interference.

In a further advantageous configuration of the method, adjustment variables from at least one adjustment table can be used for the temperature adjustment and/or for the signal shape adjustment. In this way, the corresponding adjustment variables can be accessed quickly. The at least one adjustment table can be recorded in advance, in particular at the end of a production line.

Advantageously, at least part of at least one adjustment table can be used for a plurality of detection apparatuses of one type. Production outlay, in particular calibration outlay, can be reduced in this way.

In a further advantageous configuration of the method, at least one reception signal can be detected at a plurality of temporally defined recording time ranges and a distance variable can be ascertained from reception variables assigned to the respective recording time ranges. In this way, the time characteristic of at least one part of the reception envelope curve of the at least one reception signal can be ascertained via the reception variables from the temporally defined recording time ranges. A phase difference between the reception envelope curve and the transmission envelope curve of the at least one transmission signal can be ascertained from the time characteristic of the at least one part of the reception envelope curve. Phase difference can be ascertained at least one distance variable.

Advantageously, the recording time ranges can be defined in terms of their temporal length and/or in terms of their temporal intervals. In this way, the reception envelope curve of the at least one reception signal can be ascertained more accurately.

Advantageously, the recording time ranges can be ascertained by mixing the at least one reception signal with at least one periodic mixed signal. In this way, the temporal intervals of the recording time ranges can be defined more easily. Advantageously, the recording time ranges can be ascertained by mixing the at least one reception signal with at least one periodic mixed signal and the phase-inverted at least one periodic mixed signal. In this way, the temporal lengths of the recording time ranges can be defined more accurately.

Advantageously, a phase difference between the at least one reception signal and the at least one transmission signal can be ascertained from the comparison of a respective maximum and/or a respectively corresponding turning point of the transmission envelope curve of the at least one transmission signal and of the reception envelope curve of the at least one reception signal.

Advantageously, at least one distance variable can be ascertained from at least one phase difference between the at least one transmission signal and the at least one reception signal. In this case, the phase difference can be a measure of a time-of-flight which the at least one scanning signal requires from transmission up until reception of the corresponding echo signal. The at least one distance variable can be calculated from the phase difference by taking into account the propagation speed of the scanning signal, in particular the light speed.

In a further advantageous configuration of the method, at least some of the defined recording time ranges can be placed at characteristic points of the transmission envelope curve of the at least one transmission signal. In this way, the start and/or end of the recording time ranges can be characterized and set more easily.

Advantageously, the recording time ranges can be placed at turning points and/or maxima of the transmission envelope curve. Turning points and maxima are characteristic points of the transmission envelope curve which are able to be easily ascertained.

In a further advantageous configuration of the method, if no individual temperature adjustment variable is present for a distance variable for the prevailing temperature, an appropriate temperature adjustment variable can be ascertained by means of interpolation from present temperature adjustment variables. In this way, the accuracy of the ascertainment of the distance variables can also be further improved.

In a further advantageous configuration of the method, at least one electromagnetic scanning signal can be generated from at least one electrical transmission signal. In this way, the monitoring region can be checked by means of electromagnetic scanning signals.

Advantageously, at least one light scanning signal, at least one radar scanning signal or the like can be ascertained from at least one electrical transmission signal. By means of light signals or radar signals, the monitoring region can be monitored efficiently. Electromagnetic signals can be efficiently amplitude-modulated.

Furthermore, the invention achieves the object for the detection apparatus in that the detection apparatus has means for carrying out the method according to the invention. In this way, the method according to the invention can be carried out directly in the detection apparatus.

In one advantageous embodiment, the detection apparatus can have at least one temperature adjustment means by means of which a temperature adjustment can be carried out. In this way, the temperature adjustment of the at least one distance variable can be carried out in the detection apparatus.

Advantageously, the detection apparatus can have at least one temperature ascertaining device, in particular at least one temperature sensor. In this way, the system temperature of the detection apparatus can be directly ascertained. Alternatively or additionally, the detection apparatus can be connected to an external temperature ascertaining device. In this way, the ambient temperature can be used for the temperature adjustment.

Advantageously, at least one temperature adjustment means can be implemented in at least one control and evaluation device of the detection apparatus. In this way, component outlay can be reduced.

At least one control and evaluation device, at least one adjustment means, in particular a temperature adjustment means and/or a signal shape adjustment means, can be implemented as software and/or hardware. In this case, the functions can be performed centrally in one component or in a decentralized manner in a plurality of components.

In a further advantageous embodiment, the detection apparatus can have at least one signal shape adjustment means by means of which at least one signal shape adjustment can be carried out. In this way, the signal shape adjustment can be carried out in the detection apparatus itself.

Moreover, the invention achieves the object for the vehicle in that the detection apparatus has means for carrying out the method according to the invention. In this way, the method according to the invention can be carried out directly in the detection apparatus.

The vehicle can advantageously have at least one driver assistance system. The vehicle can be operated autonomously or at least partially autonomously using the driver assistance system.

Advantageously, at least one detection apparatus can be functionally connected to at least one driver assistance system. In this way, information about the monitoring region, in particular distance variables, which can be ascertained by the at least one detection apparatus, can be sent to the at least one driver assistance system. The vehicle can be operated autonomously or at least partially autonomously using the at least one driver assistance system taking into account the information about the monitoring region.

Incidentally, the features and advantages indicated in connection with the method according to the invention, the selection apparatus according to the invention and the vehicle according to the invention and the respective advantageous configurations thereof apply in a mutually corresponding manner and vice versa. The individual features and advantages may of course be combined with one another, wherein further advantageous effects that go beyond the sum of the individual effects may emerge.

### BRIEF DESCRIPTION OF THE DRAWINGS

Further advantages, features and details of the invention will become apparent from the following description, in which exemplary embodiments of the invention are explained in greater detail with reference to the drawing. A person skilled in the art will expediently also consider individually the features that have been disclosed in combination in the drawing, the description and the claims and will combine them to form meaningful further combinations. Schematically, in the figures,

FIG. 1 shows a front view of a vehicle having a driver assistance system and a LiDAR system for determining distances from objects in relation to the vehicle;

FIG. 2 shows a functional illustration of the vehicle having the driver assistance system and the LiDAR system from FIG. 1;

FIG. 3 shows a graph of signal strength against time with a transmission envelope curve of an amplitude-modulated electrical transmission signal of the LiDAR system from FIGS. 1 and 2, from which an electromagnetic scanning signal is generated for detecting an object, and with a reception envelope curve of a correspondingly amplitude-modulated electrical reception signal which is ascertained from an electromagnetic echo signal of the reflected electromagnetic scanning signal;

FIG. 4 shows a graph of signal strength against time of the real transmission envelope curve of the electrical transmission signal from FIG. 3 with a section of the electrical transmission signal;

FIG. 5 shows a graph of signal strength against time of the real reception envelope curve of the electrical reception signal from FIG. 3 with a section of the electrical reception signal;

FIG. 6 shows a graph of signal strength against time with respective sinusoidal basic envelope curves for approximating the real transmission envelope curve of the electrical transmission signal and the real reception envelope curve of the electrical reception signal from FIGS. 3 to 5;

FIG. 7 shows a vector diagram in which the shape of the basic envelope curves from FIG. 6 is plotted against the shape of the real transmission envelope curve from FIG. 3;

FIG. 8 shows a graph in which distance errors during the determination of distances at different temperatures are plotted against the respective real distances;

FIG. 9 shows a graph in which ascertained distances are plotted against the real distances at different temperatures.

In the figures, identical components are provided with identical reference signs.

### EMBODIMENT(S) OF THE INVENTION

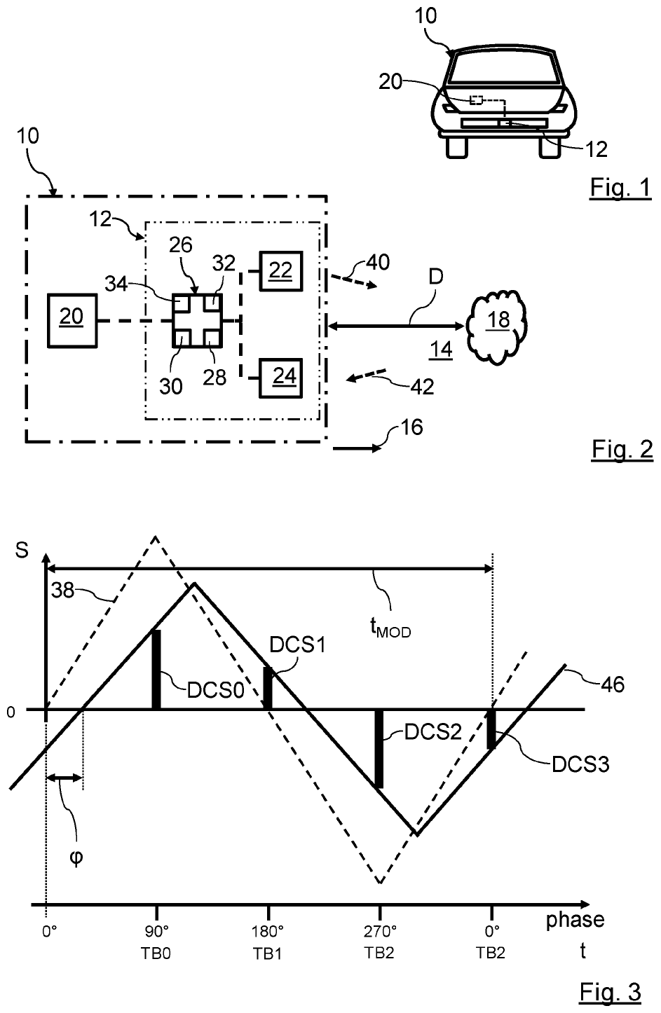

FIG. 1 shows a front view of a vehicle 10 by way of example in the form of a passenger vehicle. FIG. 2 shows a functional illustration of the vehicle 10.

The vehicle 10 has a detection apparatus by way of example in the form of a LiDAR system 12. By way of example, the LiDAR system 12 is arranged in the front fender of the vehicle 10. The LiDAR system 12 may be used to monitor a monitoring region 14 in front of the vehicle 10 in the direction of travel 16 for the presence of objects 18. The LiDAR system 12 can also be arranged at another location on the vehicle 10 and oriented differently. The LiDAR system 12 may be used to ascertain object information, for example distances D, directions and speeds of objects 18 relative to the vehicle 10, or to the LiDAR system 12.

The objects 18 may be stationary or moving objects, for example other vehicles, persons, animals, plants, obstacles, roadway unevennesses, for example potholes or rocks, roadway boundaries, traffic signs, free spaces, for example parking spaces, precipitation or the like.

The LiDAR system 12 is connected to a driver assistance system 20. The driver assistance system 20 can be used to operate the vehicle 10 autonomously or semiautonomously.

The LiDAR system 12 comprises, by way of example, a transmission device 22, a reception device 24, and a control and evaluation device 26. The control and evaluation device 26 has a distance ascertaining means 28, a temperature adjustment means 30, a signal shape adjustment means 32 and a storage means 34.

The functions of the control and evaluation device 26 can be performed centrally or in a decentralized manner. Some of the functions of the control and evaluation device 26 can also be integrated in the transmission device 22 or the reception device 24.

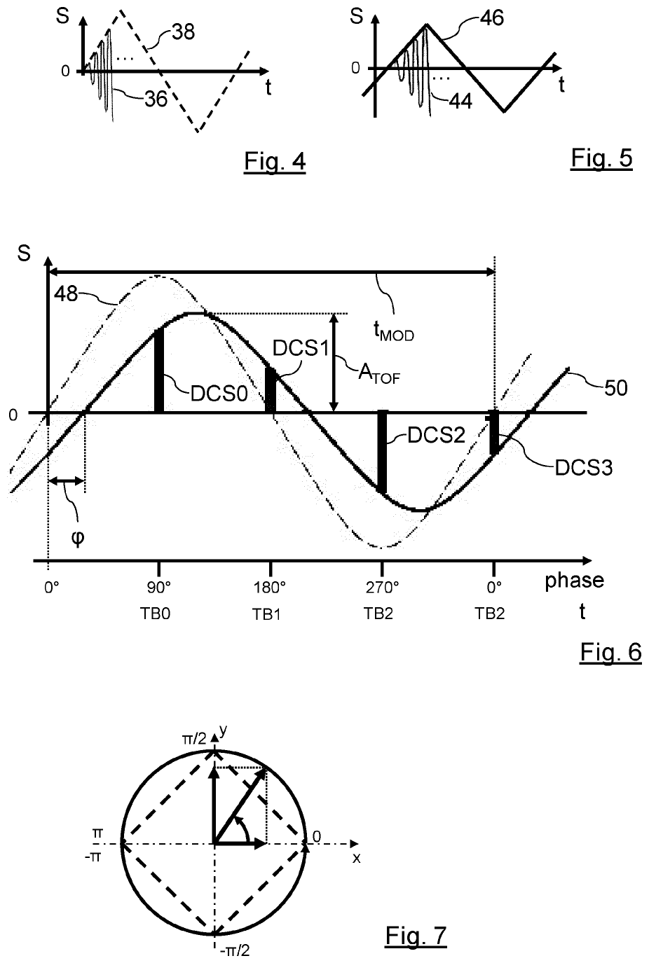

The control and evaluation device 26 can be used to generate electrical transmission signals 36, such as, for example, an amplitude-modulated continuous wave signal shown in FIG. 4. For better clarity, FIG. 4 shows only a section of the transmission signal 36 and the transmission envelope curve 38 thereof in a graph of signal strength against time. The transmission envelope curve 38 has, by way of example, the shape of a periodic triangular curve.

The transmission device 22 can be controlled by the electrical transmission signals 36 such that it transmits corresponding electromagnetic scanning signals 40 in the form of light signals into the monitoring region 14. The transmission device 22 may have, for example, one or more lasers as a light source. In addition, the transmission device 22 may optionally have a scanning-signal deflecting device by means of which the scanning signal 40 can be accordingly directed into the monitoring region 14.

The electromagnetic scanning signals 40 reflected at an object 18 in the direction of the reception device 24 as electromagnetic echo signals 42 can be received by the reception device 24.

The reception device 24 may optionally have an echo-signal deflecting device by means of which the electromagnetic echo signals 42 are directed to a receiver of the reception device 24. The receiver may have or consist of, for example, detectors, for example point sensors, line sensors and/or area sensors, in particular (avalanche) photodiodes, photodiode linear arrays, CCD sensors, active pixel sensors, in particular CMOS sensors, or the like. Alternatively, a plurality of receivers can also be provided.

The receiver can be used to convert the electromagnetic echo signal 42 into an electrical reception signal 44. FIG. 5 shows, by way of example, a section of the reception signal 44 which belongs to the transmission signal 36 from FIG. 4. Just like the corresponding transmission signal 36, the reception signal 44 is amplitude-modulated. Like the transmission envelope curve 38, the reception envelope curve 46 shown in FIG. 5 has a triangular shape.

In FIG. 3, a period of the transmission envelope curve 38 and of the reception envelope curve 46 are each plotted on the same graph of signal strength against time.

The reception envelope curve 46 is temporally offset with respect to the transmission envelope curve 38. The time offset in the form of a phase difference φ characterizes the time-of-flight between the transmission of the electromagnetic scanning signal 40 and the reception of the corresponding electromagnetic echo signal 42.

The distance D can be ascertained from the phase difference φ between the transmission envelope curve 38 and the reception envelope curve 46. The phase shift φ can therefore be used as a distance variable for the distance D. As is known, the time-of-flight is proportional to the distance D of the object 18 relative to the LiDAR system 12.

The period duration of the transmission envelope curve 38 is denoted as t_{MOD} in FIG. 3. It is the reciprocal of the modulation frequency f_{S} of the transmission signals 36:

$${f}_{S} = \frac{1}{{t}_{M O D}}$$

The method for determining the phase shift φ is described below.

The electrical reception signal 44 is detected, by way of example, at four temporally defined recording time ranges TB₀, TB₁, TB₂ and TB₃. Respective reception variables DCS₀, DCS₁, DCS₂ and DCS₃ are ascertained at the recording time ranges TB₀, TB₁, TB₂ and TB₃ from the signal strength S of the reception signal 44. As is known, the reception variables DCS₀, DCS₁, DCS₂ and DCS₃ correspond to the respective amount of light collected by the receiver of the reception device 24 during the recording time ranges TB₀, TB₁, TB₂ and TB₃.

The reception variables DCS₀, DCS₁, DCS₂ and DCS₃ characterize corresponding reception signal sections in the respective recording time range TB₀, TB₁, TB₂ and TB₃ of the reception signal 44.

Recording time ranges TB₀, TB₁, TB₂ and TB₃ each begin in a characteristic phase of the transmission signal 36, for example at a maximum or a turning point. By way of example, the recording time range TB₀ begins at a time which corresponds to a phase of 90° of the transmission signal 36. The first recording time range TB₁ begins at a time which corresponds to a phase of 180° of the transmission signal 36. The second recording time range TB₂ begins at a time which corresponds to a phase of 270° of the transmission signal 36. The third recording time range TB₃ begins at a time which corresponds to a phase of 360° of the transmission signal 36.

After the period duration t_{MOD} of the transmission envelope curve 38, the measurement begins again at a phase of 0°. The period duration t_{MOD} corresponds to a phase of 360°. The phase shift φ can only assume values between 0° and 360°. Accordingly, only distances within a distance range which lies below a uniqueness distance Dᵤₙ can be measured. The uniqueness distance Dᵤₙ is calculated as follows:

$${D}_{u n} = \frac{c}{2} \frac{1}{{f}_{S}}$$

In this case, c is the light speed and f_{S} is the modulation frequency of the transmission signal 36.

By way of example, the distance D_{TOF} is calculated by the distance ascertaining means 28 from the distance variables DCS0, DCS1, DCS2 and DCS3 on the assumption that the transmission signal 36 has a basic transmission envelope curve 48 in the form of a sinusoidal curve, as shown in FIG. 6, rather than the real transmission envelope curve 38 in the form of a triangular signal. It is accordingly assumed that the reception signal 44 has a corresponding basic reception envelope curve 50, likewise in the form of a sinusoidal curve, rather than the reception envelope curve 46 in the form of a triangular curve. The period duration t_{MOD} of the basic transmission envelope curve 48 corresponds to the period duration t_{MOD} of the transmission envelope curve 38. The distance D_{TOF} is calculated from the basic transmission envelope curves 48 and the basic reception envelope curve 50 using the reception variables DCS0, DCS1, DCS2 and DCS3 according to the following formula:

$${D}_{T O F} = \frac{c}{2} \frac{1}{2 π {f}_{S}} [ π + a tan 2 ( \frac{DCS 3 - DCS 1}{DCS 2 - DCS 0} ) ]$$

In this case, c is the light speed and f_{S} is the modulation frequency of the transmission signal 36.

Moreover, the amplitude A_{TOF} of the basic reception envelope curve 50 can be calculated from the reception variables DCS0, DCS1, DCS2 and DCS3 according to the following formula:

$${A}_{T O F} = \frac{\sqrt{{( DCS 2 - DCS 0 )}^{2} + {( DCS 3 - DCS 1 )}^{2}}}{2}$$

Subsequently, the signal shape adjustment means 32 subjects the distance D_{TOF} to a signal shape adjustment. By way of the signal shape adjustment, the deviation of the real triangular shape of the transmission envelope curve 38 and of the reception envelope curve 46 from the sinusoidal shape, assumed for the calculation, of the basic transmission envelope curve 48 and of the basic reception envelope curve 50 is taken into account. By way of example, the deviation is realized by the so-called fourth harmonic oscillation. The deviation distorts the determination of the phase shift φ and thus the distance D. For the signal shape adjustment, use is made of a signal shape adjustment table which contains signal shape adjustment values for measuring the distance D_{TOF} at discrete distance stages.

For better clarity, the signal-shape-adjusted distance D_{TOF} is denoted by D_{Fkor} hereinbelow.

The signal-shape-adjusted distance D_{TOF} is subjected to a temperature adjustment hereinbelow.

The transmission and reception components within the LiDAR system 12 have, by way of example, temperature-dependent delays. The ascertained distance values, for example the signal-shape-adjusted distance D_{Fkor}, therefore also change with the system temperature of the LiDAR system 12. It has been shown that the temperature dependency of the signal-shape-adjusted distance D_{Fkor} is dependent in particular on three components, namely
a consistent base value, for example an offset, which remains constant over all measurable distances D,
a phase change of the fourth harmonic oscillation,
a change in the gradient of baselines of deviations of ascertained distances D, namely the signal-shape-adjusted distances D_{Fkor}, from the real distances D_{Real}.

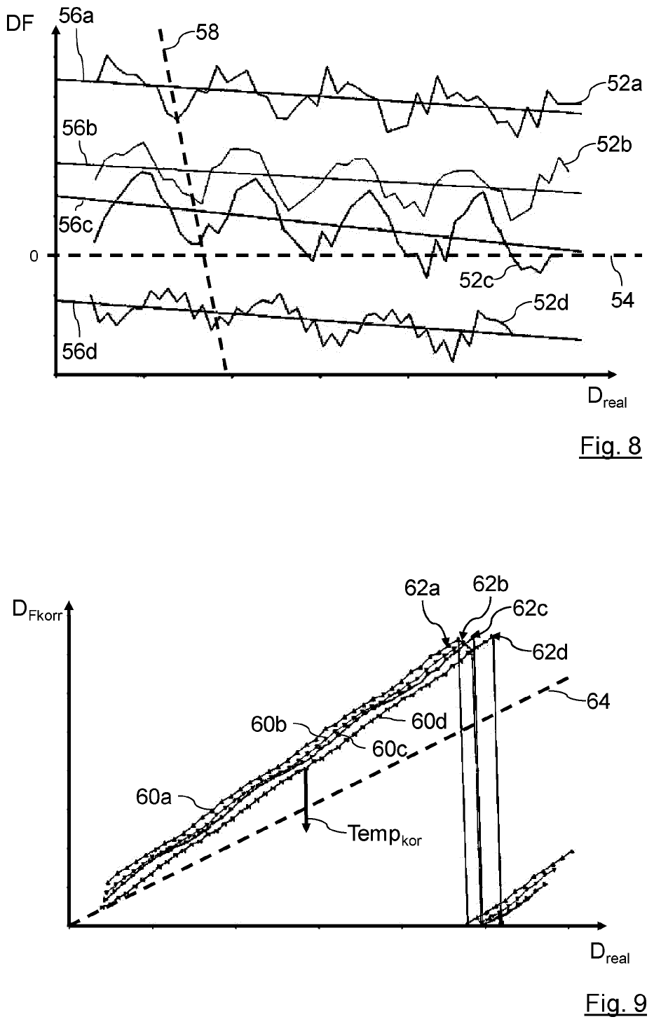

FIG. 8 shows, by way of example, the distance errors DF between ascertained signal-shape-adjusted distance D_{Fkor} and real distances D_{Real} for test measurements at four different system temperatures, namely 70° C., 50° C., 40° C. and −10° C., for an object 18 at different real distances D_{Real}.

The first error curve 52a from the top in FIG. 8 corresponds to a system temperature of the second error curve 52b corresponds to a system temperature of 50° C., the third error curve 52c corresponds to a system temperature of 40° C. and the fourth error curve 52d corresponds to a system temperature of −10° C.

In the case of an ideal LiDAR system 12, the distance error DF would be equal to zero for all real distances D_{Real}. In FIG. 8, the ideal line 54 of the error curve is indicated by a dashed line. In reality, the error curves 52a, 52b, 52c and 52d each run periodically about a respective baseline 56a, 56b, 56c and 56d. The baselines 56a, 56b, 56c and 56d each have different gradients which deviate from the gradient of the ideal line 54. The gradient of the ideal line 54 is 0.

In the example shown, error curves 52a, 52b, 52c and 52d are shifted upward with respect to the ideal line 54 by a respective individual base value. The error curve 52d is shifted downward with respect to the ideal line 54 by an individual base value.

Moreover, the phases of the error curves 52a, 52b, 52c and 52d are shifted with respect to each other, which is indicated in FIG. 8 by an imaginary dashed phase comparison line 58. In this case, the error curves 52a, 52b, 52c and 52d are shifted in the direction of smaller real distance variables D_{Real} as system temperature increases.

FIG. 9 illustrates the measurement series of distance measurements for, by way of example, four different system temperatures. In this case, the real distances D_{Real} are each plotted against the corresponding signal-shape-adjusted distances D_{Fkor}.

The measurement points 60a of the first measurement curve 62a from the left in FIG. 9 were ascertained at a system temperature of 70° C. The measurement points 60b of the second measurement curve 62b were ascertained at a system temperature of 50° C. The measurement points 60c of the third measurement curve 62c were recorded at a system temperature of 25° C. and the measurement points 60d of the fourth measurement curve 62d were recorded at a temperature of −10° C. An ideal measurement line 64 is indicated by a dashed line for comparison. On the ideal measurement line 64, the measured distances D_{Fkor} correspond to the real distances D_{Real}.

In order to compensate for temperature influences on the measurements, the temperature adjustment means 30 carries out a temperature adjustment on the signal-shape-adjusted distance D_{Fkor} hereinbelow. To this end, an individual, specified temperature adjustment variable Tempₖₒᵣ for the signal-shape-adjusted distance D_{Fkor} and the prevailing system temperature is applied to this signal-shape-adjusted distance D_{Fkor}. For easy distinction, the signal-shape- and temperature-adjusted distance is denoted by D_{Ftemp} hereinbelow. In FIG. 9, by way of example, an individual temperature adjustment variable Tempₖₒᵣ for one of the measurement points 60 at the system temperature −10° C. is indicated by an arrow.

The individual temperature adjustment variables Tempₖₒᵣ are stored in the storage means 34 in a temperature adjustment table. The individual temperature adjustment variables Tempₖₒᵣ can be ascertained in advance, for example at the end of the production line, using corresponding reference measurements.

If no individual temperature adjustment variable Tempₖₒᵣ is present in the temperature adjustment table for a signal-shape-adjusted distance variable D_{Fkor} for the prevailing system temperature, an appropriate temperature adjustment variable is ascertained by means of interpolation from temperature adjustment variables present in the temperature adjustment table. This interpolated temperature adjustment variable can be used to adjust the temperature of the corresponding signal-shape-adjusted distance D_{Fkor}. For easier differentiation, the signal-shape- and temperature-adjusted distance is denoted by D_{Ftemp} hereinbelow.

The signal-shape- and temperature-adjusted distance D_{Ftemp} is sent to the driver assistance system 20. The signal-shape- and temperature-adjusted distance D_{Ftemp} is used by the driver assistance system 20 for the autonomous or partially autonomous operation of the vehicle 10.

In order to compensate for deviations within a receiver of the reception device 24, for example from edges to the center of a reception field of the receiver, the same temperature adjustment variables Tempₖₒᵣ can be used for LiDAR systems 12 of a series of LiDAR systems 12 with identical receivers. In this way, production outlay can be reduced overall.

1. A method for operating a detection apparatus for determining distance variables which characterize distances from objects detected by the detection apparatus, thein which method comprising:
generating at least one scanning signal from at least one amplitude-modulated electrical transmission signal and is transmitted into at least one monitoring region of the detection apparatus,
at least one amplitude-modulated electrical reception signal is ascertained from at least one echo signal of at least one scanning signal reflected in the at least one monitoring region,
at least one distance variable is ascertained from at least one electrical transmission signal (36) and at least one electrical reception signal (44),
wherein, when ascertaining the at least one distance variable, at least one adjustment is carried out,
wherein a temperature adjustment is carried out in which at least one temperature adjustment variable is applied to at least one distance variable (D_{Fkorr}), which temperature adjustment variable is specified individually for the at least one distance variable and a prevailing temperature.

2. The method as claimed in claim 1, wherein the at least one distance variable is ascertained on the assumption that the at least one amplitude-modulated transmission signal and the at least one amplitude-modulated reception signal each have basic envelope curve shapes, and at least one signal shape adjustment is carried out in which deviations of real envelope curve shapes of the transmission signals and of the reception signals from the basic envelope curve shapes are adjusted.

3. The method as claimed in claim 2, wherein sinusoidal curve shapes are used as basic envelope curve shapes for at least one transmission signal and at least one reception signal and/or triangular curve shapes, sawtooth curve shapes or the like are used as real envelope curve shapes.

4. The method as claimed in claim 1, wherein adjustment variables (Tempₖₒᵣ) from at least one adjustment table are used for the temperature adjustment and/or for the signal shape adjustment.

5. The method as claimed in claim 1, wherein at least one reception signal is detected at a plurality of temporally defined recording time ranges and a distance variable is ascertained from reception variables assigned to the respective recording time ranges.

6. The method as claimed in claim 5, wherein at least some of the defined recording time ranges are placed at characteristic points of the transmission envelope curve of the at least one transmission signal.

7. The method as claimed in claim 1, wherein, if no individual temperature adjustment variable is present for a distance variable for the prevailing temperature, an appropriate temperature adjustment variable is ascertained by interpolation from present temperature adjustment variables.

8. The method as claimed in claim 1, wherein at least one electromagnetic scanning signal is generated from at least one electrical transmission signal.

9. A detection apparatus for determining distance variables which characterize distances from objects detected by the detection apparatus, the detection apparatus comprising:
at least one transmission device by which at least one scanning signal is generated from at least one amplitude-modulated electrical transmission signal and transmitted into at least one monitoring region of the detection apparatus;
at least one reception device by which at least one amplitude-modulated electrical reception signal is ascertained from at least one echo signal of at least one scanning signal reflected in the at least one monitoring region;
at least one distance ascertaining means for ascertaining at least one distance variable from at least one electrical transmission signal and at least one electrical reception signal; and
at least one adjustment means for carrying out at least one adjustment of the at least one distance variable,
wherein the detection apparatus further comprises means for carrying out the method as claimed in claim 1 one of the preceding claims.

10. The detection apparatus as claimed in claim 9, wherein the detection apparatus has at least one temperature adjustment means by which a temperature adjustment is carried out.

11. The detection apparatus as claimed in claim 9, wherein the detection apparatus has at least one signal shape adjustment means by which at least one signal shape adjustment is carried out.

12. A vehicle having at least one detection apparatus for determining distance variables which characterize distances from objects detected by the detection apparatus relative to the vehicle, the vehicle comprising:
at least one transmission device by which at least one scanning signal is generated from at least one amplitude-modulated electrical transmission signal and transmitted into at least one monitoring region of the detection apparatus;
at least one reception device by which at least one electrical reception signal is ascertained from at least one echo signal of at least one scanning signal reflected in the at least one monitoring region;
at least one distance ascertaining means for ascertaining at least one distance variable from at least one electrical transmission signal and at least one electrical reception signal; and
at least one adjustment means for carrying out at least one adjustment of the at least one distance variable,
wherein the detection apparatus has means for carrying out the method as claimed in claim 1.
